(19) United States
(12) Patent Application Publication
(10) Pub. No.: US 2025/0022149 A1
(43) Pub. Date: Jan. 16, 2025

(54) VIRTUAL ALIGNMENT OF PATHOLOGY IMAGE SERIES

(71) Applicant: H. LEE MOFFITT CANCER CENTER AND RESEARCH INSTITUTE, INC., Tampa, FL (US)

(72) Inventors: Alexander ANDERSON, Tampa, FL (US); Chandler GATENBEE, Tampa, FL (US); Mark ROBERTSON-TESSI, Lutz, FL (US)

(21) Appl. No.: 18/707,273

(22) PCT Filed: Nov. 8, 2022
(86) PCT No.: PCT/US2022/049194

§ 371 Date: May 3, 2024

Related U.S. Application Data
(60) Provisional application No. 63/276,812, filed on Nov. 8, 2021.
(60) Provisional application No. 63/297,337, filed on Jan. 7, 2022.

(51) Int. Cl. G06T 7/33; G06V 10/74; G06V 10/762

(52) U.S. Cl. CPC G06T 7/33; G06V 10/761; G06V 10/7625; G06T 2200/24; G06T 2207/10056; G06T 2207/20021; G06T 2207/30024; G06V 2201/03

(57) ABSTRACT

A method for slide image registration includes receiving slide images, detecting features contained in the slide images, comparing pairs of the slide images using the detected features, creating a distance matrix that reflects a respective difference between each of the pairs of the slide images, ordering the slide images to create a slide image series using the distance matrix, determining transformation matrices for registering the slide images, where a respective transformation matrix rigidly aligns a first slide image (Ii) to a second slide image (Ii−1), wherein i is the position of a slide image within the slide image series, and the respective transformation matrix that rigidly aligns the first and second slide images is determined using a set of the detected features shared by neighboring slide images in the slide images series, and rigidly aligning the slide images using the transformation matrices.

### CROSS-REFERENCE TO RELATED APPLICATIONS

This application claims priority to and the benefit of U.S. Provisional Patent Application No. 63/276,812, filed Nov. 8, 2021, and U.S. Provisional Patent Application No. 63/297,337, filed Jan. 7, 2022, both of which are incorporated herein by reference in their entireties.

### STATEMENT REGARDING FEDERALLY FUNDED RESEARCH

This invention was made with government support under Grant No. U01CA232382 awarded by the National Institutes of Health. The government has certain rights in the invention.

### BACKGROUND

Spatial analyses can reveal important interactions between and among cells and their microenvironment. However, most existing staining methods are limited to a handful of markers per slice, thereby limiting the number of interactions that can be studied. This limitation is frequently overcome by registering multiple images to create a single composite image containing many markers. While there are several existing image registration methods for whole slide images (WSI), most have specific use cases and are thus limited in their applications.

### SUMMARY

One implementation of the present disclosure is a computer-implemented method for slide image registration. The computer-implemented method includes receiving a plurality of slide images, detecting a plurality of features contained in the slide images, comparing a plurality of pairs of the slide images, where the comparison uses the detected features, creating a distance matrix that reflects a respective difference between each of the pairs of the slide images, ordering, using the distance matrix, the slide images to create a slide image series, determining a plurality of transformation matrices for registering the slide images, where a respective transformation matrix rigidly aligns a first slide image (Iᵢ) to a second slide image (Iᵢ₋₁), where i is the position of a slide image within the slide image series, and where the respective transformation matrix that rigidly aligns the first and second slide images is determined using a set of the detected features shared by neighboring slide images in the slide images series, and rigidly aligning the slide images using the transformation matrices.

In some implementations, the computer-implemented method further includes determining a plurality of non-rigid transformations for non-rigidly registering the rigidly aligned slide images, where a respective non-rigid transformation non-rigidly aligns a first rigidly aligned slide image (Jᵢ) to a second rigidly aligned slide image (Jᵢ₋₁), where i is the position of a rigidly aligned slide image within the slide image series.

In some implementations, the computer-implemented method further includes non-rigidly aligning the rigidly aligned slide images using the non-rigid transformations.

In some implementations, the computer-implemented method further includes identifying the set of the detected features shared by the neighboring slide images using a sliding window filter.

In some implementations, the neighboring slide images includes the first slide image and a third slide image (Iᵢ₊₁).

In some implementations, the neighboring slide images further include the second and third slide images.

In some implementations, comparing a plurality of pairs of the slide images includes comparing each one of the slide images to each of the other slide images, where the distance matrix is created from the comparison.

In some implementations, the step of ordering, using the distance matrix, the slide images to create the slide image series includes sorting the distance matrix by performing hierarchical clustering.

In some implementations, sorting the distance matrix by performing hierarchical clustering yields a dendrogram.

In some implementations, the dendrogram includes a plurality of leaves, each leaf corresponding to one of the slide images.

In some implementations, the computer-implemented method further includes performing optimal leaf ordering on the dendrogram.

In some implementations, the computer-implemented method further includes optimizing the alignment of one or more of the slide images in the slide image series.

In some implementations, the computer-implemented method further includes pre-processing the slide images.

In some implementations, the computer-implemented method further includes overlaying the aligned slide images for display on a graphical interface.

In some implementations, the slide images are whole slide images or regions of interest (ROI), stained using immunohistochemistry (IHC) or immunofluorescence (IF), coming from serially sliced samples, or cyclically stained samples.

In some implementations, the computer-implemented method further includes generating a non-rigid registration mask by combining tissue masks for each of the rigidly-aligned slide images, where the non-rigid registration mask includes only areas where the tissue masks for each of the rigidly-aligned slide images overlap or touch.

In some implementations, the plurality of slide images is a first set of slide images and the computer-implemented method further includes receiving a second set of slide images, where the second set of slide images has a higher resolution than the first set of slide images, using the non-rigid registration mask to identify a portion of at least one of the second set of slide images that includes an area of tissue shown in the first set of slide images, and repeating the computer-implemented method using the portion the at least one of the second set of slide images.

In some implementations, the computer-implemented method further includes the plurality of slide images is a first set of slide images and the computer-implemented method further includes receiving a second set of slide images, where the second set of slide images has a higher resolution than the first set of slide images, repeating the computer-implemented method using the second set of slide images, determining a plurality of non-rigid transformations for non-rigidly registering the rigidly aligned second set of slide images, where a respective non-rigid transformation non-rigidly aligns a first rigidly aligned slide image (Jᵢ) to a second rigidly aligned slide image (Jᵢ₋₁), where i is the position of a rigidly aligned slide image within the slide image series.

The computer-implemented method of claim 18, where, prior to repeating the computer-implemented method using the second set of slide images, each of the second set of slide images is divided into a plurality of tiles, where each of the plurality of tiles are used to repeat the computer-implemented method.

Another implementation of the present disclosure is a system including a processor, and a memory operably coupled to the processor, the memory having computer-executable instructions stored thereon that, when executed by the processor, cause the processor to receive a plurality of slide images, detect a plurality of features contained in the slide images, compare a plurality of pairs of the slide images, where the comparison uses the detected features, create a distance matrix that reflects a respective difference between each of the pairs of the slide images, order, using the distance matrix, the slide images to create a slide image series, determine a plurality of transformation matrices for registering the slide images, where a respective transformation matrix rigidly aligns a first slide image (Iᵢ) to a second slide image (Iᵢ₋₁), where i is the position of a slide image within the slide image series, and where the respective transformation matrix that rigidly aligns the first and second slide images is determined using a set of the detected features shared by neighboring slide images in the slide images series, and rigidly align the slide images using the plurality of transformation matrices.

In some implementations, the instructions further cause the processor to determine a plurality of non-rigid transformations for non-rigidly registering the rigidly aligned slide images, where a respective non-rigid transformation non-rigidly aligns a first rigidly aligned slide image (Jᵢ) to a second rigidly aligned slide image (Jᵢ₋₁), where i is the position of a rigidly aligned slide image within the slide image series.

In some implementations, the instructions further cause the processor to non-rigidly align the rigidly aligned slide images using the non-rigid transformations.

In some implementations, the instructions further cause the processor to identify the set of the detected features shared by the neighboring slide images using a sliding window filter.

In some implementations, the slide images are whole slide images or regions of interest (ROI), stained using immunohistochemistry (IHC) or immunofluorescence (IF), coming from serially sliced samples, or cyclically stained samples.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a set of example images from a dataset registered by the Virtual Alignment of pathoLogy Image Series (VALIS) system and method described herein, according to some implementations.

FIG. 2 is a diagram of an image alignment (e.g., VALIS) pipeline, according to some implementations.

FIG. 3 is a graph of example benchmarking results of VALIS on an example dataset, according to some implementations.

FIGS. 4A-4H are example images used for testing VALIS, according to some implementations.

FIGS. 5A-5C are example graphs illustrating the results of registering the example images of FIGS. 4A-4H using VALIS, according to some implementations.

FIGS. 6A-6D are example images illustrating potential applications of VALIS, according to some implementations.

FIGS. 7A-7F are example images illustrating registration using VALIS performed on Cyclic Immunofluorescence (CyCIF) images, according to some implementations.

FIG. 8 is a block diagram of a computing device for implementing VALIS, according to some implementations.

FIG. 9 is a diagram of example performance metrics for VALIS, according to some implementations.

FIG. 10 is a summary of VALIS performance using an example dataset, according to some implementations.

### DETAILED DESCRIPTION

Described herein is a system and methods for virtual alignment of pathology image series, referred to as Virtual Alignment of pathoLogy Image Series (VALIS). VALIS is a fully automated pipeline that opens, registers (rigid and/or non-rigid), and saves aligned slides in the ome.tiff format. VALIS has been tested with 273 immunohistochemistry (IHC) samples and 340 immunofluorescence (IF) samples, each of which contained between 2-69 images per sample. The registered WSI tend to have low error and are completed within a matter of minutes. In addition to registering slides, VALIS can also using the registration parameters to warp point data, such as cell centroids previously determined via cell segmentation and phenotyping.

### Overview

Cellular interactions and the structure of the tumor microenvironment can affect tumor growth dynamics and response to treatment (Gallaher, Enriquez-Navas, Luddy, Gatenby, & Anderson, 2018; Heindl et al., 2018; Lewis et al., 2021). Interactions and the effect of tissue structure can be elucidated via spatial analyses of tumor biopsies, although there are many challenges. Among these is the limited number of markers that can be detected on a single tissue section. This can be overcome by repeated cycles of staining on the same tissue section, or by staining serial slices for different subsets of markers. However, the captured images will likely not align spatially, due to variance in tissue placement on the slide, tissue stretching/tearing/folding, and changes in physical structure from one slice to the next. Without accurate alignment, spatial analyses remain limited to the number of markers that can be detected on a single section. While there are methods that can stain for a large number of markers on a single slide, they are often highly expensive, destructive, and require considerable technical expertise (Angelo et al., 2014; Gerdes et al., 2013; Giesen et al., 2014; Goltsev et al., 2018; Hennig, Adams, & Hansen, 2009). Furthermore, much archival tissue is available that has limited stains per slice.

Image registration is the process of aligning one image to another such that they share the same coordinate system, and therefore offers the potential to align histology images. However, a pre-requisite for successful image registration is that the images look similar, but this requirement is rarely satisfied in histological images. The reasons for this may include: spatial variation in color intensity due to markers binding in different regions of the slide; lack of a common marker across images (in the case of IHC); inter-user or inter-platform variation in staining intensity; tissue deformations (e.g. stretching, folds, tears); unknown order of serial sections; large numbers of images; and massive file sizes, often several GB when uncompressed.

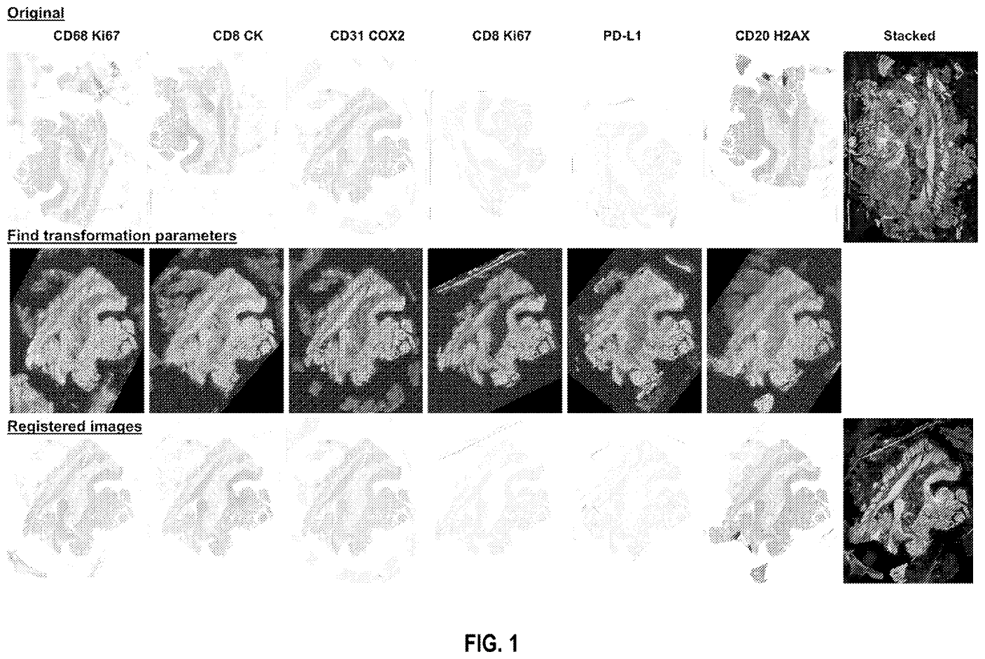

FIG. 1, shows a set of example images from a dataset registered by VALIS, according to some implementations. VALIS handles potential batch effects from IHC images that would otherwise make image registration challenging. Such batch effects include large displacements (rotation, translation, etc.); deformations (stretches, tears); and spatial variation in color and luminosity due to differing spatial distributions of markers and/or different staining protocols. Large file sizes also present challenges to registering whole slide images (WSI). In the top row of images in FIG. 1, six serial slices of a colorectal adenoma were stained by three different individuals, with each marker stained with Fast Red or DAB. Note the substantial spatial variation in color and brightness, due to the heterogeneous spatial distribution of different cell types (each type stained with a different marker), and different staining protocols where some images are heavily stained, and others lightly stained. The rightmost image shows the result of stacking the un-registered images, where each color shows the normalized inverted luminosity of each image. Each slide is also too large to open in memory, with each being approximately 32 gigabytes (GB) when uncompressed. The bottom row of images in FIG. 1 show alignment of the same slides using VALIS (left) and an image stack after image registration using VALIS (right). The transformations found by VALIS can subsequently be used warp each of the 32 Gb slides, which can be saved as ome.tiff images for downstream analyses.

There are several existing methods to register histological images, many of which have been reviewed in (Jiri Borovec, Mu5 oz-Barrutia, & Kybic, 2018; Paknezhad et al., 2020). Some are limited to hematoxylin and eosin (H&E) staining (Arganda-Carreras et al., 2006; du Bois d'Aische et al., 2005; Kiemen et al., 2020; Wang, Ka, & Chen, 2014), while others are designed to work with slides stained for different markers (J. Borovec, Kybic, Busta, Ortiz-de-Solórzano, & Mu5 oz-Barrutia, 2013; Deniz, Toomey, Conway, & Bueno, 2015; Kybic & Borovec, 2014; Kybic, Dolejsi, & Borovec, 2015; Obando et al., 2017; Song, Treanor, Bulpitt, & Magee, 2013). Some are designed to align only 2 slides (Levy, Jackson, Haudenschild, Christensen, & Vaickus, 2020), while others can align multiple slides (Kiemen et al., 2020; Paknezhad et al., 2020). There also exist several methods to register immunofluorescence (IF) images, which can be an easier task as each image usually contains a DAPI channel that stains for nuclei (Muhlich, Chen, Russell, & Sorger, 2021). Most seem to require the user be able open the slides, apply the transformation, and then save the registered image. All these methods also focus exclusively on IHC or IF images. Thus, while each method has many benefits, they also have limitations that can reduce their use cases.

For a method to be scalable, it must: be able to read, warp, and write full resolution WSI to facilitate downstream analyses; be fully automated; have a command line interface so that the registrations can be performed on high performance computer (HPC) clusters; be freely available. Only a handful of published methods have the complete set of features that make a method scalable. However, those that do have the ability to scale tend to be designed for specific problems, such as: aligning only brightfield images (Jiang, Larson, Prodduturi, Flotte, & Hart, 2019; Liang, Chang, Fang, & Chen, 2021; Marzahl et al., 2021; Mahsa Paknezhad et al., 2020; Venet et al., 2021); aligning only images that have been stained with H&E (Kiemen et al., 2020); designed to construct an image by registering raw image tiles, meaning it can't be applied to the stitched images that are already poorly aligned (Schapiro et al., 2021). Importantly, each of these methods require the user to specify a reference image to which the others will be aligned. Selecting the correct reference image is not trivial, especially when an H&E image is not available. Choice of a reference image can make or break the method when applied to datasets with more than two images. This is because for these methods to work, one must determine which slide looks most like the others, and if that chosen slide is not similar enough to the rest, the registration can fail, as some may align to it while others do not.

VALIS aims to combine the best of current approaches while remaining easy to use. VALIS provides the following advantages:
1. VALIS is flexible and unique, as it is able to align both immunohistochemistry (IHC) and immunofluorescence (IF) images, whole slide images (WSIs) or regions of interest (ROIs), H&E images or collections of different markers, serial slices and/or cyclically stained images (tested using 11-20 rounds of staining).
2. VALIS can register any number of images, find rigid and/or non-rigid transformations, and apply them to slides saved using a wide variety of slide formats (via Bio-Formats or OpenSlide), and then save the registered slides in the ome.tiff format (Gohlke, 2021; Goldberg et al., 2005; Goode, Gilbert, Harkes, Jukic, & Satyanarayanan, 2013; Linkert et al., 2010; Martinez & Cupitt, 2005).
3. VALIS is designed to be extendable, giving the user the ability to provide additional rigid and/or non-rigid registration methods;
4. A user may also provide transformations found using other methods but still use VALIS to warp and save the slides.
5. The transformations found by (or provided to) VALIS can be applied not only to the original slide, but also processed versions of the slide (e.g., ones that have undergone stain segmentation) which could be merged.
6. The transformations found by VALIS can also be used to warp point data, such as cell positions;

Thus, VALIS provides a simple and fully automated registration pipeline to open, register, and save a series of pathological images.

VALIS provides several features that are useful for WSI registration. For example, VALIS is a new groupwise, multi-resolution, rigid and/or non-rigid registration method that can align any number of images while solving the issue of needing to define a reference image. VALIS is easy to use and can register brightfield images, and/or register and merge IF images. VALIS that can read 322 formats using Bio-Formats or Openslide, meaning it can be used with the majority of WSI (Goode, Gilbert, Harkes, Jukic, & Satyanarayanan, 2013; Linkert et al., 2010). VALIS can warp and save huge multi-gigapixel WSI as ome.tiff, an opensource image format that can store multiple large pyramid images with metadata, making it ideal for WSI (Gohlke, 2021; Goldberg et al., 2005; Goode et al., 2013; Linkert et al., 2010; Martinez & Cupitt, 2005). VALIS can be used to warp coordinates using image transformation parameters and could therefore be used to warp cell coordinates from existing cell segmentation data. VALIS can also warp images with user provided 190 transformations and/or registration methods (by sub-classing the relevant object classes). VALIS can convert WSI to ome.tiff.

### Method Overview

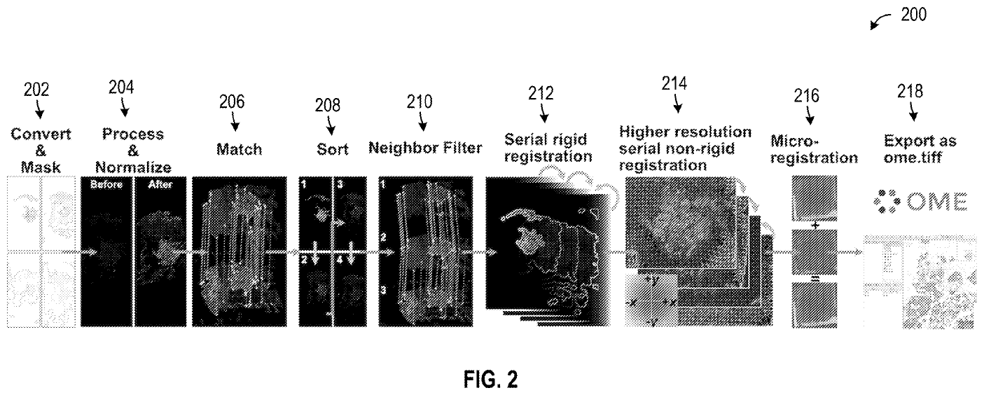

Referring now to FIG. 2, a diagram of the VALIS alignment pipeline 200 is shown, according to some implementations. In some implementations, pipeline 200 is a representation of a method for registering slides using VALIS. For example, in some implementations, pipeline 200 is a computer implemented method. VALIS uses Bio-Formats to read the slides and convert them to images for use in the pipeline. As an initial step (not shown in FIG. 2), slides are obtained. In various implementations, slides are received from a remote system, device, or database, or are retrieved from a database. For example, slides may be captured by suitable medical imaging equipment and stored in a database for later retrieval and processing. As another example, pipeline 200 may be used to process slides that are stored in a dataset.

Initially, the obtained slides are converted into a suitable format for processing. Once converted from slides, images are processed and normalized to look as similar as possible. Features are detected in each image and then matched between all possible pairwise combinations. Feature distances are used to construct a distance matrix, which is then clustered and sorted, ordering the images such that each image should be adjacent to its most similar image. Once ordered, the images are registered serially, first using rigid transformations, and then (optionally) with non-rigid transformations. The results of the registration can be viewed by overlaying the processed images. Once registration is complete, the slides can be warped and saved as ome.tiff images.

### Reading the Slides

WSIs can be challenging to work with because they are saved using a wide variety of formats. They are often very large in size (greater than 70,000 pixels in width and height) and have multiple channels. The resulting uncompressed file is frequently on the order of 20 GB in size, which precludes opening the entire image directly. To address the issues of working with WSI, at step 202, VALIS coverts the WSIs to other formats. In some implementations, VALIS uses Bio-Formats and OpenSlide (Goode et al., 2013; Linkert et al., 2010) to read each slide in small tiles, covert those tiles to libvips images, and then combine the tiles to rebuild the entire image as single whole-slide libvips image (Linkert et al., 2010; Martinez & Cupitt, 2005). As libvips uses “lazy evaluation”, the WSI can then be warped without having to load it into memory, making it ideal for large images. Using this approach, VALIS is thus able to read and warp any slide that Bio-Formats can open.

### Mask Creation

Also at step 202, in some implementations, VALIS generates tissue masks for each image to help focus registration on the tissue and thus avoid attempting to align background noise. The underlying idea is to separate background (slide) from foreground (tissue) by calculating how dissimilar each pixel's color is from the background color. The first step converts the image to the CAM16-UCS colorspace, yielding L (luminosity), A, and B channels. In the case of brightfield images, it is assumed that the background will be bright, and so the background color is the average LAB value of the pixels that have luminosities greater than 99% of all pixels. The difference to background color is then calculated as the Euclidean distance between each LAB color and the background LAB, yielding a new image, D, where larger values indicate how different in color each pixel is from the background. Otsu thresholding is then applied to D, and pixels greater than that threshold are considered foreground, yielding a binary mask. The final mask is created by using OpenCV to find and then fill in all contours, yielding a mask that covers the tissue area. The mask can then be applied during feature detection and non-rigid registration to focus registration on the tissue.

### Preprocessing

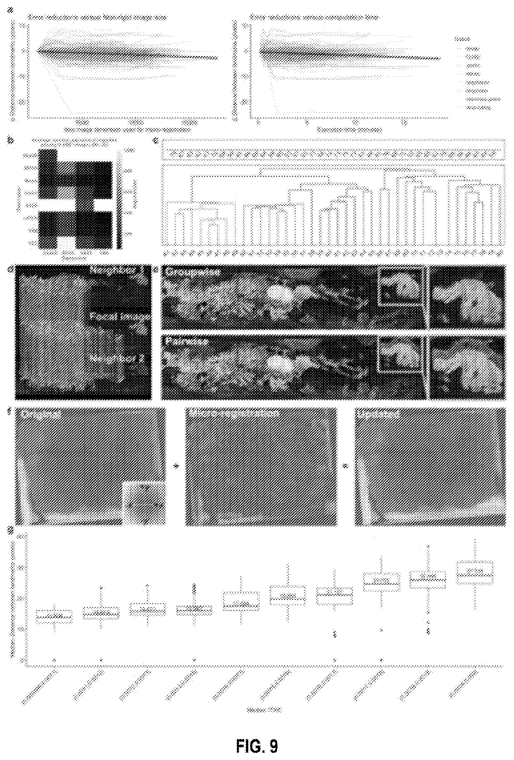

At step 204, various preprocessing and normalizing techniques are applied. In some implementations, VALIS uses tissue features to find the transformation parameters, and therefore a lower resolution version of the image is used for feature detection and finding the displacement fields used in non-rigid registration. The lower resolution image is usually acquired by accessing an upper level of an image pyramid. However, if such a pyramid is unavailable, VALIS can use libvips to rescale the WSI to a smaller size. In some implementations, the images used for feature detection are usually between 500-2000 pixels in width and height. Prior to feature detection, in some implementations, all or some processed images are re-sized such that all have the same largest dimension (i.e. width or height). It has been found that increasing the size of the image used for registration does not always increase accuracy, and that gains tend to be small, despite the fact that WSI are frequently substantially larger than the default 850 pixels in width and/or height used by VALIS (see FIG. 9).

For image registration to be successful, images generally need to look as similar as possible. In the case of IF, the DAPI channel is often the best option to use for registration. However, unless one is only working with H&E, a preprocessing method to make IHC images look similar must be used. The default method in VALIS is to first to re-color each image to have the same hue and colorfulness. This is accomplished by converting the RGB image to the polar CAM16-UCS colorspace (C. Li et al., 2017), setting C=100 and H=0 (other values can be used), and then converting back to RGB. The transformed RGB image is then converted to greyscale and inverted, such that the background is black, and the tissue bright. After all images have been processed (IHC and/or IF), they are then normalized such that they have similar distributions of pixel values. The normalization method is inspired by (Khan, Rajpoot, Treanor, & Magee, 2014), where first the 5^{th} percentile, average, and 95^{th} percentile of all pixel values is determined. These target values are then used as knots in cubic interpolation, and then the pixel values of each image are fit to the target values.

### Rigid Registration

At step 206, features in each image are detected and matched to features in other images. In some implementations, a plurality of features that are contained in the image(s) are detected. The plurality of features can then be used to compare pairs of slide images. VALIS provides a novel pipeline to rigidly align a large number of unsorted images, using feature detecting and matching. A major benefit of using feature-based registration is that it can cope with large displacements, and thus does not require the images to already be somewhat aligned. The default feature detector and descriptor are BRISK and VGG, respectively (L. Li, Huang, Gu, & Tian, 2003; Simonyan, Vedaldi, & Zisserman, 2014). This combination was selected after conducting experiments which showed that the BRISK/VGG pair consistently found the largest number of good matches between 4 serially sliced H+E images in each of 27 samples (see FIG. 9). In some implementations, features can then be matched using brute force, with outliers removed using the RANSAC method (Fischler & Bolles, 1981). The remaining “good” matches can then be used to find the rigid transformation parameters.

RANSAC does an excellent job of removing most outliers, but some still get considered as get considered as inliers. Including the coordinates of such mismatched features will produce poor estimates of the transformation matrices that will align feature coordinates, resulting in inaccurate alignments. To address this, in some implementations, a secondary match filtering can be performed using Tukey's box plot approach to outlier detection at step 206. Specifically, a preliminary rigid transformation matrix between source image Iᵢ and target image Iⱼ, M_{i,j}′, is found and used to warp the source image's feature coordinates to their position in target image. Next, the Euclidean distances between warped source and target coordinates are calculated, d_{i,j}′. Inliers are considered to be those with distances between the lower and upper “outer fences”, i.e., between Q1−3IQR and Q3+3IQR, where Q1 and Q1 are the first and third quartiles of d_{i,j}′, and IQR is the interquartile range of d_{i,j}′.

In order to increase the chances of successful registration, at steps 208 and 210, VALIS orders (e.g., sorts) the images such that each image is surrounded by the two most similar images. In other words, at step 208, the images are sorted, and, at step 210, filtering is applied to identify neighboring images. This is accomplished by using matched features to construct a similarity matrix S, where the default similarity metric is simply the number of good matches between each pair of images. S is then standardized such the maximum similarity is 1, creating the matrix S′, and then converted to the distance matrix, D=1−S′ at step 210. Hierarchical clustering is then performed on D, generating a dendrogram T. The order of images can then be inferred by optimally ordering the leaves of T, such that most similar images are adjacent to one another in the series (Bar-Joseph, Gifford, & Jaakkola, 2001). This approach was validated by reordering a shuffled list of 40 serially sliced H+E images from (Wang et al., 2014), where the original ordering of images is known. All 40 images were correctly ordered (see FIG. 9), indicating that this approach is capable of sorting images such that each image is neighbored by similar looking images. In some implementations, this step can be skipped if the order of images is known.

Once the order of images has been determined, at step 212, VALIS finds the transformation matrices that will rigidly warp each image to the previous image in the series. That is, each image Iᵢ will have an associated transformation matrix Mᵢ that rigidly aligns it to image Iᵢ₋₁, where i is the position of the image in the series. While RANSAC does an excellentj ob of removing poor matches, those mismatched features are sometimes considered inliers and thus potentially used to estimate transformation matrices. Including the coordinates of such mismatched features will produce poor estimates of the transformation matrices that will align feature coordinates the idea being that matches found in both neighbors reflect good tissue feature matches (see FIG. 9). To avoid this, only features that are found in the image and its neighbors are used. That is, the features used to align image Iᵢ and Iᵢ₋₁ are the features that Iᵢ also has in common with Iᵢ₊₁, and thus consequently that Iᵢ₋₁ also has in common with Iᵢ₊₁. The assumption here is that features which are found in Iᵢ and its neighborhood are shared because they are strong tissue landmarks, and thus ideal for alignment. This approach may be thought of as using a sliding window to filter out poor matches by using only features shared within an image's neighborhood/community. The coordinates of the filtered matches are then used to find the transformation matrix (Mᵢ) that rigidly aligns Iᵢ to Iᵢ₋₁.

After warping all images using their respective rigid transformation matrices, the series of images has been registered. However, one can optionally use an intensity-based method to improve the alignment between Iᵢ and Iᵢ₋₁. The default in VALIS is to maximize Mattes mutual information between the images, while also minimizing the distance between matched features (Lowekamp, Chen, Ibanez, & Blezek, 2013). Once optimization is complete, Mᵢ will be updated to be the matrix found in this optional step. This step is optional because the improvement (if any) may be marginal (distance between features improving by fractions of a pixel), and it is time consuming.

### Non-Rigid Registration

In some implementations, pipeline 200 includes a step 214 of non-rigid registration. Non-rigid registration involves finding 2D displacement fields, X and Y, that warp a “moving” image to align with a “fixed” image by optimizing a metric. As the displacement fields are non-uniform, they can warp the image such that local features align better than they would with non-rigid transformations (Crum, Hartkens, & Hill, 2004). However, these methods require that the images provided are already somewhat aligned. Therefore, once VALIS has rigidly registered the images, they can be passed on to one of these non-rigid methods.

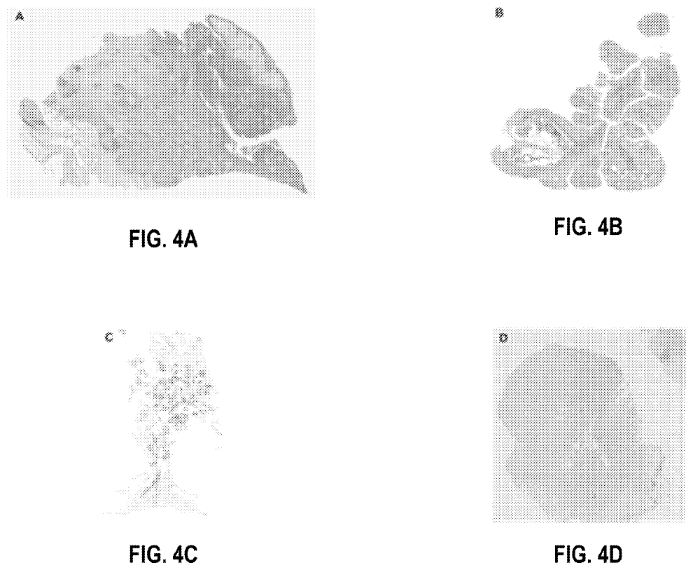

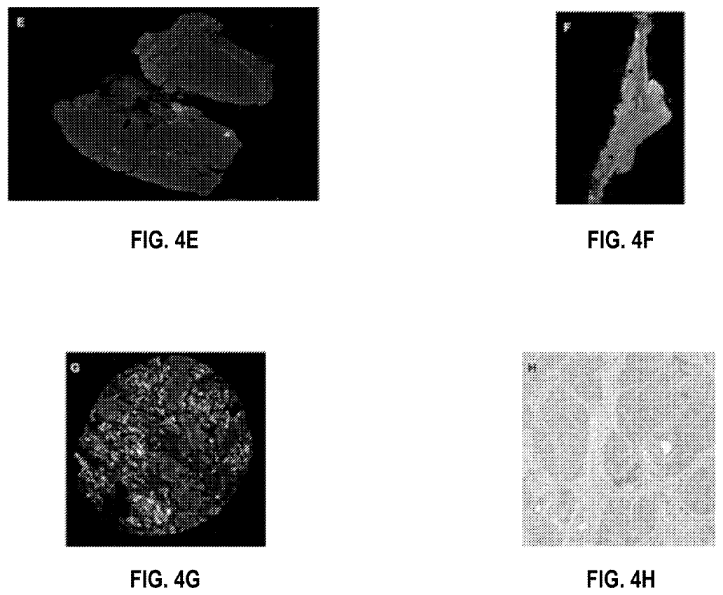

Recall that rigid registration is performed on low resolution copies of the full image. However, it may be that the tissue to be aligned makes up only a small part of this image, and thus the tissue is at extremely low resolution. However, the lack of detailed alignment can be overcome during the non-rigid registration step, which can be performed using higher resolution images. A “higher resolution” or “high resolution” image is generally any image having a file size the is greater than the low-resolution images described above. In some implementations, a “high resolution” image is at or above 5 GB in size. For example, a 10 GB image is generally considered “high resolution.” This is accomplished by first creating a non-rigid registration mask, which is constructed by combining all rigidly aligned image masks, keeping only the areas where all masks overlap and/or where a mask touches at least one other mask. The bounding box of this non-rigid mask can then be used to slice out the tissue at a higher resolution from the original image (FIGS. 4A-4H). These higher resolution images are then processed and normalized as before, warped with the rigid transformation parameters, and then used for non-rigid registration. This approach makes it possible to non-rigidly register the images at higher resolution without loading the entire high resolution image into memory, increasing accuracy at a low computational cost (due to re-processing the image).

VALIS can conduct this non-rigid registration using one of three methods: Deep Flow, SimpleElastix, or Groupwise SimpleElastix (Klein, Staring, Murphy, Viergever, & Pluim, 2010; Marstal, Berendsen, Staring, & Klein, 2016; Shamonin et al., 2013; Weinzaepfel, Revaud, Harchaoui, & Schmid, 2013). In the case of the first two methods, images are aligned towards the image at the center of the series. For example, given N images, the center image is

$${I}_{( \frac{N}{2} )} .$$

Therefore

$${I}_{( \frac{N}{2} ) - 1}$$

is aligned to

$${I}_{( \frac{N}{2} )} ,$$

then

$${I}_{( \frac{N}{2} ) - 2}$$

is aligned to the non-rigid warped version of

$${I}_{( \frac{N}{2} ) - 1} ,$$

and so on. Each image's displacement fields, Xᵢ and Yᵢ, are built through composition. A benefit of accumulating transformations serially is that distant features can be brought together, which may not occur if performing direct pairwise registration (see FIG. 9). For the third method (Groupwise SimpleElastix), this process of aligning pairs of images and composing displacement fields is not necessary, as it uses a 3D free-form B-spline deformation model to simultaneously register all the images.

### Micro-Registration

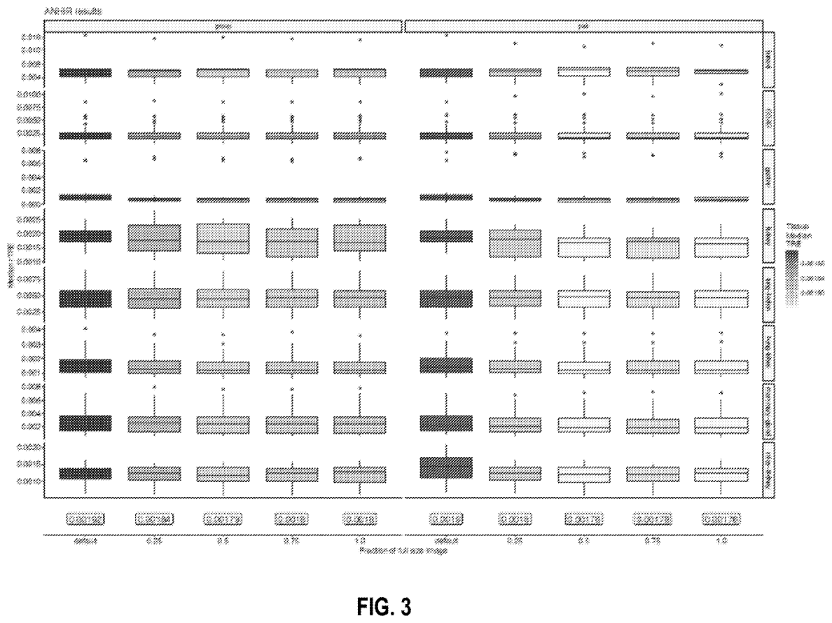

The above transformations are found using lower resolution images, but a second optional non-rigid registration can be performed using higher resolution images, which may improve alignment of “micro-features” not visible in the smaller image used for the initial registration. Thus, pipeline 200 may optionally include a step 216 of micro-registration. This is accomplished by first scaling and applying the above transformations to a larger image, and then performing a second non-rigid registration following the steps described above. This yields two new deformation fields, Xᵢ′ and Yᵢ′, which can be added to the original displacement fields to get updated displacements that will align microstructures (see FIG. 9). If the images are large (e.g., greater than 10 Gb), each image will be divided into tiles, which will be registered, and each tile's deformation fields stitched together to create the full size deformation fields. A caveat is that the increase in accuracy may be small and the computational cost high, so this step is optional (see FIG. 9). An alternative use of this micro-registration step can be to directly align images to a specified reference image after performing the default groupwise registration. This can be a good approach after using the groupwise method because all images should be closely aligned, and this step can improve the alignment directly to the reference image. An example of how this can improve registration to a target image is shown in FIG. 3, below.

### Warping and Saving

Once the transformation parameters Mᵢ, Xᵢ, and Yᵢ have been found, they can be scaled and used to warp the full resolution image at step 218. In some implementations, this scaling and warping which is accomplished using libvips. The warped full resolution image can then be saved as an ome.tiff image, with the ome-xml metadata being generated by tifffile and saving done using libvips (Gohlke, 2021; Goldberg et al., 2005; Linkert et al., 2010). Once saved as an ome.tiff, the registered images can be opened and analyzed using open-source software such as QuPath (Bankhead et al., 2017) or commercially available software, such as Indica Labs HALO® (Albuquerque, NM, USA) image analysis software. As the ome.tiff slides can be opened using libvips or Bio-Formats, one can also use the aligned slide in a more tailored analysis using custom code.

### Contributions

While VALIS' registration method uses existing feature detectors, feature descriptors, and non-rigid registration methods, it does so in a new way. The approach of using feature matches to create and sort an image similarity matrix enables a pipeline that increases registration accuracy and has several additional benefits:
1. Sorting the images and then aligning serially ensures that images are aligned to the most similar looking image, increasing the chances of successful registration for each image pair.
2. Feature match quality is improved by using only the matches found in both neighbors, which should be indicative of strong tissue features. This reduces the number of poor matches included in the estimation of rigid registration parameters, thereby increasing registration accuracy. This is only possible because the images have been sorted by similarity, and so an image can access the shared features of its neighbors.
3. Ordering the images and aligning them serially solves the non-trivial problem of selecting a reference image. If aligning more than two images, selecting the wrong reference image can cause a registration to fail. This can be especially challenging if an H&E image is not available, as it may not be obvious which image looks most similar to the rest.
4. Because transformations accumulate, distant features in dissimilar images can be better aligned than might be possible if only performing pairwise registration. This too is only possible because the images have been sorted and aligned serially (see FIG. 9).
5. Since images are sorted and aligned serially, any number of images can be registered at the same time, in contrast to manually conducting several pairwise alignments. Again, this is only possible because images were ordered by similarity.

In addition to presenting a new groupwise registration method, the preprocessing method described here is stain agnostic. Instead of extracting stains through color deconvolution (which requires providing or estimating a stain matrix, a challenge in itself), this method's approach is to standardize each image's colorfulness/chroma. This allows VALIS to work with a wide variety of stains. Another important contribution of VALIS is that it provides a bridge between Bio-formats and libvips, making it possible to read, register, and write huge multi-gigapixel WSI saved in a wide variety of formats. This interface is also available to the user, which will help others in their projects with very large WSI saved in specialized formats.

### Results

VALIS was benchmarked using the Automatic Non-rigid Histological Image Registration (ANHIR) Grand Challenge dataset (Borovec et al., 2020). This includes eight datasets of brightfield images originating from different tissues, with multiple samples and stains per dataset. Each image is accompanied by hand selected tissue landmarks that are evenly distributed across the image and found in all other serial slices taken from the same sample, making it possible to measure biologically meaningful alignment accuracy between pairs of images. In total, there are 49 unique samples, with public training landmarks available for 230 image pairs. There are an additional 251 private landmark pairs used to evaluate registration accuracy after the user has uploaded their results. Therefore, the results presented on the leaderboard may differ slightly than what the user calculates using the publicly available landmarks.

The goal of the challenge is to register pairs of images, the accuracy of which can be measured by applying the transformations to the landmarks and then measuring the distance between the newly registered landmarks. More specifically, error is measured as the median relative target registration error (median rTRE), where rTRE is the Euclidean distance between registered landmarks, divided by the diagonal of the target image, thereby normalizing error between 0-1. In addition to benchmarking VALIS using default parameters (e.g., groupwise registration using the default image sizes and no micro-registration), VALIS performance was assessed using micro-registration, both using the groupwise approach, or registering directly to the target image after an initial groupwise registration. These experiments were conducted by performing micro-registration at four different levels of downsampling: 0.25, 0.5, 0.75, 1.0 (i.e., the full resolution image).

The results of these experiments can be found in FIG. 3, which shows benchmarking results of VALIS using the publicly available ANHIR Grand Challenge dataset. Values are the median rTRE for each image pair used to assess registration accuracy. Each major column is for a registration strategy, with “group” meaning only groupwise registration was performed, while “pair” means that micro-registration was used to directly align each image to the target image after the initial groupwise registration. Minor columns indicate the amount of downsampling used for the micro-registration. Values inside the bubbles the bottom of each minor column indicate the median median rTRE for all image pairs, the default metric used to rank methods on the ANHIR leaderboard. Rows indicate the tissue type. In each box, the center line indicates the median, the top and bottom indicate the 75th and 25th percentiles, respectively, the top whisker the largest value that is no further than 1.5 Interquartile range (IQR) from the 75th percentile, the bottom whisker the smallest value no more than 1.5IQR from the 25th percentile, and points indicate outliers. VALIS was also benchmarked in the AutomatiC Registration of Breast cAncer Tissue (ACROBAT) grand challenge, which was part of MICCAI 2022. Like ANHIR, the goal was to align pairs of images, but the dataset was composed of “real-world” images from routinely collected samples, and so contained many challenging artifacts, such as tissue tears, stain smears, slide cracking, and the like. Accuracy of methods was measured by calculating the physical distance between hand annotated tissue landmarks.

Referring now to FIGS. 4A-4H, various example of images used to test VALIS are shown, according to some implementations. FIG. 4A, in particular, shows squamous cell carcinoma of the head and neck (HNSCC). This sample set included 4 marker panels, each of which included between 13-20 markers stained using IHC. A single slice underwent the corresponding number of stain wash cycles, but all 69 images collected from the 4 panels have also been co-registered. FIG. 4B shows human colorectal carcinoma or adenoma IHC serial slices, each with 1-2 markers per slide, and 6 slides per sample. FIG. 4C shows DCIS and invasive breast cancer serial slices, 1-2 markers per slide (stained using IHC), 7 slides per sample. FIG. 4D shows human colorectal carcinomas and adenomas, stained using RNAscope, 1-2 markers per slide, 5 slides per sample. FIG. 4E shows human colorectal carcinomas and adenomas, stained using cyclic immunofluorescence (CyCIF), 11-12 images per sample. FIG. 4F shows human colorectal carcinomas and adenomas stained using immunofluorescence, two slides per sample. In addition to registering WSI, VALIS can also be used to register images with cellular resolution, such as cores from an immunofluorescent tumor microarray (TMA) taken from human ovarian cancers (2 slides per sample), as shown in FIG. 4G, or 40× regions of interest from HNSCC samples, taken from images in the same dataset in FIG. 4A, as shown in FIG. 4H.

### Registration Validation

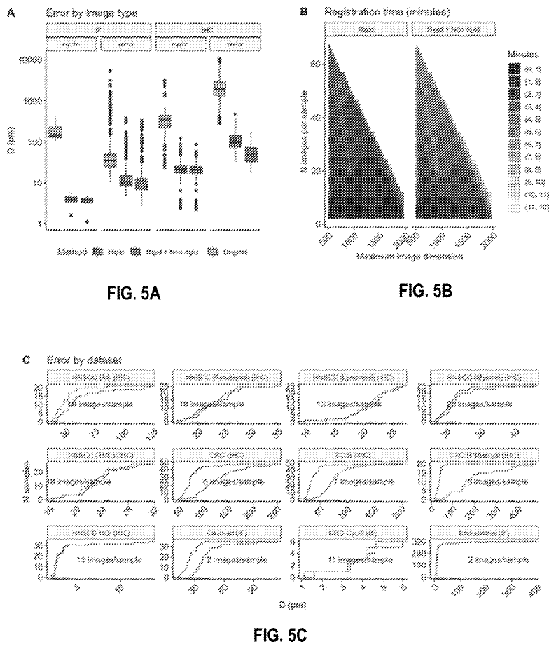

Referring now to FIGS. 5A-C, example results of registering images from the datasets shown in FIGS. 4A-4H, which were captured from a variety of tissues, protocols, imaging modalities, and resolutions, are shown, according to some implementations. FIG. 5A, in particular, shows boxplots showing the distance (μm) between matched features in the full resolution slides, before registration (yellow), after rigid registration (red), and then non-rigid registration (blue). FIG. 5B shows a median amount of time (minutes) taken to complete registration, as a function of processed image's size (by largest dimension, on the x-axis) and the number of images being registered. These timings include opening/converting slides, pre-processing, and intensity normalization. FIG. 5C shows empirical cumulative distribution plots of registration error for each image dataset.

To test the robustness of VALIS, image registration was performed on 613 samples, with images capture under a wide variety of conditions (see FIGS. 4A-4H). Each sample had between 2 to 69 images; 273 were stained using immunohistochemistry (IHC), and 340 using immunofluorescence (IF); 333 were regions of interest (ROI) or cores from tumor microarrays (TMA), while 280 were whole slide images (WSI); the original image dimensions ranged from 2656×2656, to 104568×234042 pixels in width and height; 162 underwent stain/wash cycles, 451 were serial slices; 49 came from breast tumors, 109 from colorectal tumors, 156 from squamous cell carcinoma of the head and neck (HNSCC), and 299 from ovarian tumors.

For the most part, the default parameters and methods were used to align the images in all of the datasets. The exception was how much to resize the images. Typically, full slides were resized to have a maximum width or height around 2000 pixels, while smaller images with cellular resolution (e.g., TMA cores) were resized to have maximum width or height around 500 pixels. For each image, registration error was calculated as the median distance (μm) between the features in the image and the corresponding matched features in the previous image. The registration error of the sample was then calculated as the average of the images' registration errors, weighted by the number of matched features per pair of images. The registrations provided by VALIS substantially improved the alignments between images, particularly in the case of serial IHC.

### Applications

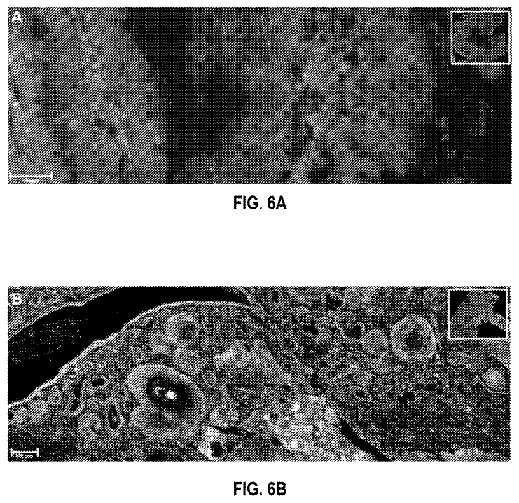

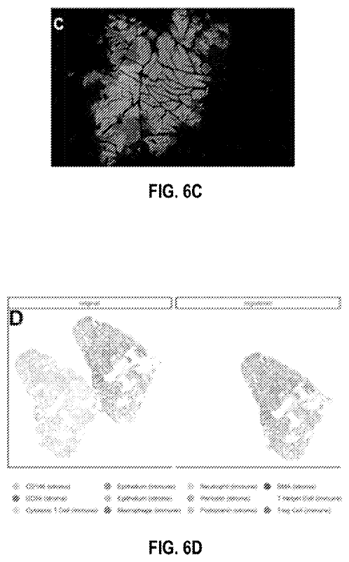

Referring now to FIGS. 6A-6D, various potential applications of VALIS are shown, according to some implementations. FIG. 6A, for example, illustrates merging registered CyCIF slides, in this case creating a 32-channel image. FIG. 6B illustrates merging registered and processed IHC slides. Here, VALIS found the transformation parameters using the original images, but applied the transformations to 18 stain segmented versions slides (see Table S3 for list of markers). FIG. 6C illustrates registering an H&E slide with the DAPI channel of an IF slide, which may be useful in cases where annotations H&E images would like to be used with IF images. Here, to visualize the alignment, the registered H&E image is overlaid on the DAPI channel. FIG. 6D illustrates applying transformations to cell segmentation data.

Alignment error was low for samples that underwent cyclic immunofluorescence (CyCIF), with an average distance between matched features (in the full resolution slide) being 2-6 μm apart. In these cases, the quality of the image registration was high enough that cell segmentation and phenotyping could be performed, as shown in FIG. 6A. Alternatively, one could also prepare the data for a spatial analysis by having VALIS warp the cell positions from an existing dataset (FIG. 6D). FIG. 6D shows that VALIS can be used co-register H&E and IF images, which could be used to find ROI in the IF images, based on annotated H&E images.

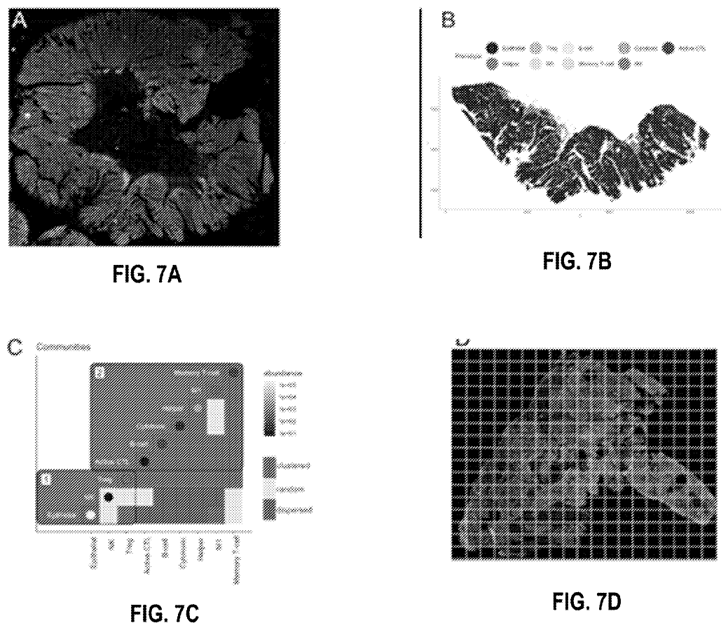

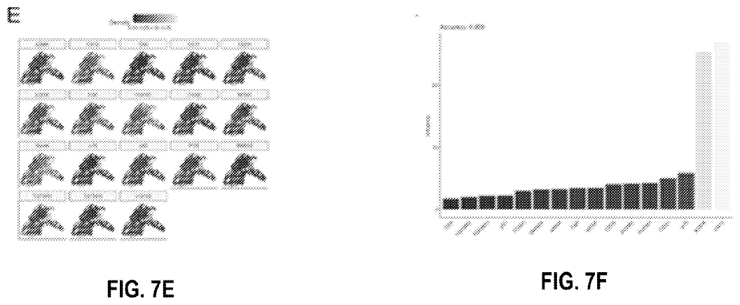

Registration performed on CyCIF images was highly accurate, with an alignment error less than 10 μm, which is about 1 cell diameter (FIGS. 5A-5C and 6A). In these cases, the registration is accurate enough that cell segmentation and phenotyping could be performed. An example of such an analysis can be found in FIGS. 7A-7F. HALO was used for cell segmentation and marker thresholding using the 32-channel image created by merging 11 rounds of registered CyCIF images (FIGS. 6A and 7A, below). For a full description of the channels, refer to Table S1. A spatial analysis of the distribution of immune cells within the carcinoma region was conducted using 13 of the 32 markers, which were used to classify cells into one of nine cell types: helper T cells, cytotoxic T cells, regulatory T cells (Treg), natural killer (NK) T cells, active cytotoxic T cells (active CTL), memory T cells, M1 macrophages, M2 macrophages, B-cells, and tumor cells (FIG. 7B, below, and Table S2).

Referring now to FIGS. 7A-7D, example analyses using registered CyCIF WSI are shown, according to some implementations. In FIG. 7A, 32-channel image was created by registering and merging several rounds of CyCIF. The HALO platform was then used to perform cell segmentation and marker thresholding. In FIG. 7B, within the carcinoma region, a spatial analysis was conducted to determine the spatial relationship between 10 cell types, defined by different combinations of 13 markers. The pattern was determined using the DCLF test, where cell types could be found closer than expected (clustered), randomly distributed, or further apart than expected (dispersed). In FIG. 7C, observed patterns were used to construct a weighted network (1=clustered, 0=random, −1=dispersed), which subsequently underwent community detection. These results indicate the carcinoma (Epithelial) is largely isolated from the immune system. FIG. 7D shows a composite IHC image of HNSCC using 18 markers of the tumor microenvironment. Alignment of IHC may not be cell-cell perfect, but using ecological methods, a spatial analysis can be conducted using quadrat counts. Each aligned slide underwent stain segmentation, the results of which were merged into a single composite image that was divided into regular quadrats. In FIG. 7E, the number of positive pixels of each marker was calculated for each quadrat. In FIG. 7F, a species distribution model was fit to the data to determine the role of each marker in creating a pro-tumor environment. Here, CA12 and EGFR were found to play the largest roles in creating a tumor supporting habitat.

A spatial analysis of the immune composition was conducted by first determining the spatial pattern observed between each pair of cell types (e.g. clustered, complete spatial randomness (CSR), or dispersion). Significance of departure from CSR was determined using the Diggle-Cressie-Loosmore-Ford (DCLF) test on the cross-type L-function for homogeneous point patterns (i.e. Besag's transformation of Ripley's K function) (Besag, 1977; Diggle, 1986; B. D. Ripley, 1977; B. D Ripley, 1981). These tests were conducted using the spatstat package for R (Baddeley, Rubak, & Turner, 2015; R Core Team, 2019). Clustering was considered significant when p≤0.05 for the alternative hypothesis of “greater”, i.e. there were more cells within a radius r than expected under CSR. The spatial pattern was classified as dispersion when p≤0.05 for alternative hypothesis of “lesser”. These patterns were then used to construct a weighted adjacency matrix, where 1=clustered, 0=CSR, and −1=dispersed (FIG. 6C). The matrix was then divided into communities using the Leiden community detection algorithm (Traag, Waltman, & van Eck, 2019). This analysis revealed that the tumor (in community 1) is largely isolated from immune system (community 2).

Spatial analyses can also be conducted when alignments are not close enough for cell segmentation. One approach is to first divide the image into quadrats, and then count cells and/or quantify the markers in each quadrat. One can then can select from a wide variety of methods to conduct a spatial analysis of the quadrat counts. For example, one can create spatial association networks, species distribution models, and test for complete spatial randomness (Baddeley et al., 2015; Hijmans, Phillips, Leathwick, & Elith, 2017; Popovic, Warton, Thomson, Hui, & Moles, 2019).

Examples of spatial analyses of histological data with ecological methods based on quadrat counts or multiple subregions can be found in (C. Gatenbee et al., 2021; Chandler D. Gatenbee et al., 2019; C. D. Gatenbee, Minor, Slebos, Chung, & Anderson, 2020; Maley, Koelble, Natrajan, Aktipis, & Yuan, 2015). Here, a brief example is provided using a sample that went through 18 stain/wash cycles, each time being stained for one of 18 tumor microenvironment (TME) markers (FIG. 5B, 6D-F) (EGFR, H&E, FAP, α-SMA, TGFBR2, p16, FGFR1, TGFBR3, PCK, VGFR2, MTAP, CD34, CA9, p53, SMAD4, ITGA5, CA12, CD31). Each image underwent stain segmentation, the results of which were merged to create a single 18-channel composite slide (FIGS. 6B and 7D). This slide was then divided into 100 μm×100 μm quadrats, and the number of positive pixels per quadrat for each marker was recorded (FIGS. 7A and 7B). A species distribution model was then fit to the quadrat counts, which allowed us to quantify the importance of each marker in creating a hospitable tumor microenvironment (FIG. 7C). The results from this analysis indicate that EGFR and CA12 play the largest role in creating a pro-tumor microenvironment.

### Example Computing Device

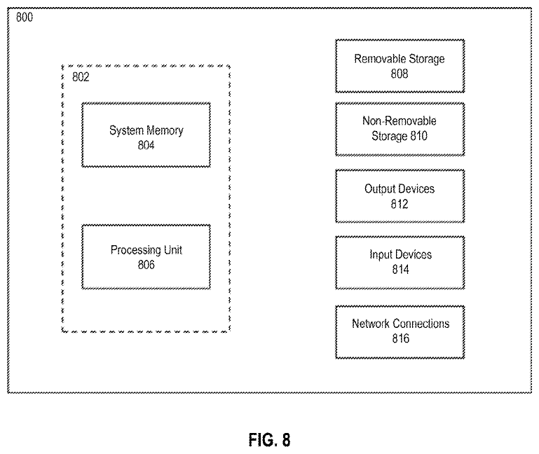

It should be appreciated that the logical operations described herein with respect to the various figures may be implemented (1) as a sequence of computer implemented acts or program modules (i.e., software) running on a computing device (e.g., the computing device described in FIG. 8), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 8, an example computing device 800 upon which the methods described herein may be implemented is illustrated. It should be understood that the example computing device 800 is only one example of a suitable computing environment upon which the methods described herein may be implemented. Optionally, the computing device 800 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 800 typically includes at least one processing unit 806 and system memory 804. Depending on the exact configuration and type of computing device, system memory 804 may be volatile (such as random access memory (RAM)), non-volatile (such as read-only memory (ROM), flash memory, etc.), or some combination of the two. This most basic configuration is illustrated in FIG. 8 by dashed line 802. The processing unit 806 may be a standard programmable processor that performs arithmetic and logic operations necessary for operation of the computing device 800. The computing device 800 may also include a bus or other communication mechanism for communicating information among various components of the computing device 800.

Computing device 800 may have additional features/functionality. For example, computing device 800 may include additional storage such as removable storage 808 and non-removable storage 10 including, but not limited to, magnetic or optical disks or tapes. Computing device 800 may also contain network connection(s) 816 that allow the device to communicate with other devices. Computing device 800 may also have input device(s) 814 such as a keyboard, mouse, touch screen, etc. Output device(s) 812 such as a display, speakers, printer, etc. may also be included. The additional devices may be connected to the bus in order to facilitate communication of data among the components of the computing device 800. All these devices are well known in the art and need not be discussed at length here.

The processing unit 806 may be configured to execute program code encoded in tangible, computer-readable media. Tangible, computer-readable media refers to any media that is capable of providing data that causes the computing device 800 (i.e., a machine) to operate in a particular fashion. Various computer-readable media may be utilized to provide instructions to the processing unit 806 for execution. Example tangible, computer-readable media may include, but is not limited to, volatile media, non-volatile media, removable media and non-removable media implemented in any method or technology for storage of information such as computer readable instructions, data structures, program modules or other data. System memory 804, removable storage 808, and non-removable storage 810 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 806 may execute program code stored in the system memory 804. For example, the bus may carry data to the system memory 804, from which the processing unit 806 receives and executes instructions. The data received by the system memory 804 may optionally be stored on the removable storage 808 or the non-removable storage 810 before or after execution by the processing unit 806.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### Discussion

VALIS introduces a new groupwise WSI rigid and/or non-rigid registration method that increases the chances of successful registration by ordering images such that each will be aligned to their most similar image. This is performed serially, meaning that transformations accumulate, aligning all images towards the center of the image stack or a specified reference image. Since images are aligned as a group, there is no need to select a reference image, which can make or break a registration. There is an emphasis on acquiring good rigid registration, which in turn facilitates accurate non-rigid registration. This is accomplished through automated pre-processing, normalization, tissue masking, and three rounds of feature match filtering (RANSAC, Tukey's approach, and neighbor match filtering) (FIGS. 4A-4H). VALIS also provides the option to refine the registration through micro-registration using a larger image. Finally, VALIS is flexible, being able to register both brightfield and fluorescence images.

Combined with the selection of feature detectors, feature descriptors, and non-rigid registration method, this method can provide registrations with state of the art accuracy. In addition to other applications that can benefit from image registration (e.g., using annotations across multiple images, retrieving regions of interest in multiple images, warping cell coordinates, etc.), VALIS also makes it possible to construct highly multiplexed images from collections multi-gigapixel IF and/or IHC WSI. However, a challenge of constructing multiplexed images by combining stain/wash cycling and image registration is that multiple cycles eventually degrade the tissue and staining quality can decrease because antibody binding weakens as the number of cycles increases. It has been estimated that t-CyCIF images can reliably undergo 8-10 rounds of stain/wash, and possibly up to 20 in some cases (Lin et al., 2018). In the examples provided herein, three unique markers were used per cycle, suggesting one could construct a 24-60 plex image using a similar protocol. This number may increase as technological advances in stain protocols are made.

To maximize the number of markers used to generate multiplexed images with image registration, one can conduct experiments wherein each individual antibody undergoes multiple stain/wash cycles, measuring antibody sensitivity after each repeat. One can then use the results of these experiments to determine how many cycles an antibody can undergo while maintaining sensitivity. With this data in hand, one can order the staining sequence such that weaker stains are used first, and more robust stains used in the later cycles. Such an approach should help maximize the number markers one can stain for. Using this approach, it was found that staining sequences that allowed between 13-20 IHC stain/wash cycles per tissue slice (HNSCC data in FIG. 6C).

The impacts of stain/wash cycles on stain quality does not appear to extend to registration accuracy. The CyCIF images, which underwent 11 cycles, had very low registration error, the maximum being estimated at 6 μm. Likewise, most samples in the HNSCC panels had similar error distributions, despite each undergoing differing numbers of IHC staining rounds, being between 13 and 20 rounds depending on the stain panel (HNSCC data in FIG. 6C). These results did not include the micro-registration step, which should bring the error even lower. These experiments suggest stain/wash cycling has little impact on registration accuracy, and that VALIS is able to “fix” tissue deformations that can occur during repeated washing.

In addition to introducing anew groupwise WSI registration method, VALIS has several additional useful features. First, it is able to read, warp, and write multi-gigapixel WSI images saved in a wide variety of formats, something currently unique to VALIS. Being software, it also provides several convenient functions for working with WSI, such as warping coordinates, converting WSI to libvips Image objects (excellent for working with very large images), warping WSI with user provided transformations, converting slides to ome.tiff format while maintaining original metadata, and visualization of high dimensional images with pseudo-coloring using perceptually uniform color palettes. VALIS is also designed such that it is possible to add new feature detectors, descriptors, and non-rigid registration methods, meaning that it can updated and improved over time, not being limited to the current choices or imaging modalities. As such, VALIS offers more than just access to a new WSI registration method, and which will help others with their work using WSI. In that vein, issues and feature requests can be handled through GitHub, such that VALIS can grow and accommodate the scientific image analysis community's needs.

### Supplemental

Referring now to FIG. 9, which is referenced throughout the present disclosure, a diagram of example performance metrics for VALIS is shown, according to some implementations. In particular, FIG. 9 shows a) change in accuracy as a function of the size of the image used for non-rigid registration (left) and computation time (right). The y-axis shows how much the distance between registered landmarks changed with increasing image size (and therefore computation time), when compared to the results using the default parameters. b) Number of “good” matches between 4 serially sliced H&E images in 26 samples, given different combinations of feature detectors (columns) and feature descriptors (rows). Empty boxes (white) indicate that the feature descriptor/detector pair is incompatible. This experiment shows that the BRISK/VGG combination consistently found the largest number of good matches, which is why they were selected as the defaults. c) Experiment testing image sorting. The top box shows the initial order of 40 serially sliced H&E images, while the bottom box shows their order after being sorted by optimally ordering the leaves of a hierarchically clustered image feature distance matrix. d) Example of neighbor match filtering. The focal image will be aligned to neighbor 1, but only using features that were also found in neighbor 2. Pink lines indicate feature found in the image and neighbor 1 but not neighbor 2, blue lines show features found in the image and neighbor 2 but not 1, and green lines show features found in all 3 images. e) Example showing how serial groupwise registration can bring distant features together. In the “groupwise” panel, images were aligned serially towards the center of the stack. As transformations accumulate, the distant images essentially have their features moved towards the center image. In contrast, when conducting direct pairwise registration, the top right piece of the tissue was too far displaced for it to be moved to the correct location. f) Micro-registration is performed by scaling the original displacements (left) for a larger image, using them to warp the larger image, and then non-rigidly registering those larger image. This produces new displacement fields that align the micro-features found in the higher resolution images (middle). The micro-registration displacement fields can be added to the original scaled displacement fields to get a new displacement field for the larger image (right). In each displacement field image, the hue indicates the direction of the displacement, while the luminosity represents the magnitude of the displacement. Colors are relative for each displacement field. g) Relationship between median rTRE and registered landmark distance for rTRE between 0.001 and 0.002 using the ANHIR Grand Challenge dataset. Text indicates the median distance between registered landmarks for the respective rTRE range.

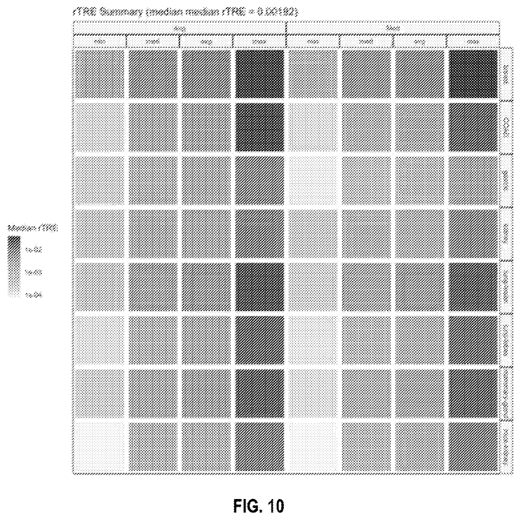

Referring now to FIG. 10, a summary of VALIS performance using an example dataset is show, according to some implementations. In particular, the ANHIR Grand Challenge dataset, mentioned above, was used. Each minor column is a summary of each tissue's median rTRE values, with min=minimum, med=median, avg=average, and max=maximum. The major column “Avg” is the average of the summary statistics, while “Med” is the median of the summary statistics.

TABLE S1
Markers per registered CyCIF round.
In addition to the markers lists, each
round also had DAPI channel,
which was used to register the rounds.

| CyCIF Round | Non-DAPI Channels |
|---|---|
| Round 1 | pHH3 |
| | iNOS |
| | CD45 |
| Round 2 | CD163 |
| | CK |
| | CD8 |
| Round 3 | CD44 |
| | HLA-DR |
| | PD-1 |
| Round 4 | Ecad |
| | CD3 |
| | CD20 |
| Round 5 | CD4 |
| | γ-H2AX |
| | PD-L1 |
| Round 6 | CD45RO |
| | FoxP3 |
| | α-SMA |
| Round 7 | p53 |
| | CD68 |
| | CD31 |
| Round 8 | CD11b |
| | IDO1 |
| | Vista |
| Round 9 | β-catenin |
| | HLAABC |
| | Myelo |
| Round 10 | CD45RB |
| | Ki67 |
| | CD57 |
| Round 11 | CD163 |
| | CK |
| | Vimentin |

TABLE S2
Cell phenotypes, and the makers used to
define those phenotypes, used in the
example spatial analysis using registered
CyCIF rounds (FIGS. 5B, 6B-C).

| Phenotype | Marker(s) |
|---|---|
| helper T cells | CD3, CD4 |
| cytotoxic T cells | CD3, CD8 |
| regulatory T cells (Treg) | CD3, FOXP3 |
| natural killer (NK) T cells | CD3, DD57 |
| active cytotoxic T cells (active CTL) | CD3, CD8, HLA-DR |
| memory T cells | CD3, CD8, CD45RO |
| M1 macrophages | CD68, iNOS |
| M2 macrophages | CD68, CD163 |
| B-cells | CD20 |
| tumor cells | CK and/or E-cadherin |

TABLE S3
Markers used in example spatial
analysis of registered IHC
images (FIGS. 5B, 6D-F).
Marker
MTAP
CD34
ITGA5
p53
p16
FAP
EGFR
TGFBR2
TGFBR3
SMAD4
FGFR1
PanCK
CA9
aSMA
VGFR2
CD31
CA12

### REFERENCES

Angelo, M., Bendall, S. C., Finck, R., Hale, M. B., Hitzman, C., Borowsky, A. D., . . . Nolan, G. P. (2014). Multiplexed ion beam imaging of human breast tumors. Nat Med, 20(4), 436-442. doi:10.1038/nm.3488
Arganda-Carreras, I., Sorzano, C. O. S., Marabini, R., Carazo, J. M., Ortiz-de-Solorzano, C., & Kybic, J. (2006, 2006//). Consistent and Elastic Registration of Histological Sections Using Vector-Spline Regularization. Paper presented at the Computer Vision Approaches to Medical Image Analysis, Berlin, Heidelberg.
Baddeley, A., Rubak, E., & Turner, R. (2015). Spatial Point Patterns: Methodology and Applications with R. London: Chapman and Hall/CRC Press.
Bankhead, P., Loughrey, M. B., Fernandez, J. A., Dombrowski, Y., McArt, D. G., Dunne, P. D., . . . Hamilton, P. W. (2017). QuPath: Open source software for digital pathology image analysis. Sci Rep, 7(1), 16878. doi:10.1038/s41598-017-17204-5
Bar-Joseph, Z., Gifford, D. K., & Jaakkola, T. S. (2001). Fast optimal leaf ordering for hierarchical clustering. Bioinformatics, 17 Suppl 1, S22-29. doi:10.1093/bioinformatics/17.suppl_1. s22
Besag, J. (1977). Discussion of Dr Ripley's paper. Journal of the Royal Statistical Society. Series B (Methodological), 39, 193-195.
Borovec, J., Kybic, J., Busta, M., Ortiz-de-Solórzano, C., & Muñoz-Barrutia, A. (2013, 7-11 Apr. 2013). Registration of multiple stained histological sections. Paper presented at the 2013 IEEE 10th International Symposium on Biomedical Imaging.
Borovec, J., Muñoz-Barrutia, A., & Kybic, J. (2018). Benchmarking of Image Registration Methods for Differently Stained Histological Slides.
Crum, W. R., Hartkens, T., & Hill, D. L. (2004). Non-rigid image registration: theory and practice. Br J Radiol, 77 Spec No 2, S140-153. doi:10.1259/bjr/25329214
Deniz, O., Toomey, D., Conway, C., & Bueno, G. (2015). Multi-stained whole slide image alignment in digital pathology. Progress in Biomedical Optics and Imaging—Proceedings of SPIE, 9420. doi:10.1117/12.2082256
Diggle, P. J. (1986). Displaced amacrine cells in the retina of a rabbit: analysis of a bivariate spatial point pattern. Journal of Neuroscience Methods, 18(1), 115-125. doi:https://doi.org/10.1016/0165-0270(86)90115-9
du Bois d'Aische, A., Craene, M. D., Geets, X., Gregoire, V., Macq, B., & Warfield, S. K. (2005). Efficient multi-modal dense field non-rigid registration: alignment of histological and section images. Med Image Anal, 9(6), 538-546. doi:10.1016/j.media.2005.04.003
Fischler, M. A., & Bolles, R. C. (1981). Random sample consensus: a paradigm for model fitting with applications to image analysis and automated cartography. Commun. ACM, 24(6), 381-395. doi:10.1145/358669.358692
Gallaher, J. A., Enriquez-Navas, P. M., Luddy, K. A., Gatenby, R. A., & Anderson, A. R. A. (2018). Spatial Heterogeneity and Evolutionary Dynamics Modulate Time to Recurrence in Continuous and Adaptive Cancer Therapies. Cancer Res, 78(8), 2127-2139. doi:10.1158/0008-5472.CAN-17-2649
Gatenbee, C., Baker, A.-M., Schenck, R., Strobl, M., West, J., Neves, M., . . . Anderson, A. (2021). Nature Portfolio. doi:10.21203/rs.3.rs-799879/vl
Gatenbee, C. D., Baker, A.-M., Schenck, R. O., Neves, M. P., Hasan, S. Y., Martinez, P., . . . Anderson, A. R. A. (2019). Niche engineering drives early passage through an immune bottleneck in progression to colorectal cancer. bioRxiv, 623959. doi:10.1101/623959
Gatenbee, C. D., Minor, E. S., Slebos, R. J. C., Chung, C. H., & Anderson, A. R. A. (2020). Histoecology: Applying Ecological Principles and Approaches to Describe and Predict Tumor Ecosystem Dynamics Across Space and Time. Cancer Control, 27(3), 1073274820946804. doi:10.1177/1073274820946804
Gerdes, M. J., Sevinsky, C. J., Sood, A., Adak, S., Bello, M. O., Bordwell, A., . . . Ginty, F. (2013). Highly multiplexed single-cell analysis of formalin-fixed, paraffin-embedded cancer tissue. Proc Natl Acad Sci USA, 110(29), 11982-11987. doi:10.1073/pnas.1300136110
Giesen, C., Wang, H. A., Schapiro, D., Zivanovic, N., Jacobs, A., Hattendorf, B., . . . Bodenmiller, B. (2014). Highly multiplexed imaging of tumor tissues with subcellular resolution by mass cytometry. Nat Methods, 11(4), 417-422. doi:10.1038/nmeth.2869
Gohlke, C. (2021). tifffile. Laboratory for Fluorescence Dynamics, University of California, Irvine.
Goldberg, I. G., Allan, C., Burel, J. M., Creager, D., Falconi, A., Hochheiser, H., . Swedlow, J. R. (2005). The Open Microscopy Environment (OME) Data Model and XML file: open tools for informatics and quantitative analysis in biological imaging. Genome Biol, 6(5), R47. doi:10.1186/gb-2005-6-5-r47
Goltsev, Y., Samusik, N., Kennedy-Darling, J., Bhate, S., Hale, M., Vazquez, G., . . . Nolan, G. P. (2018). Deep Profiling of Mouse Splenic Architecture with CODEX Multiplexed Imaging. Cell, 174(4), 968-981 e915. doi:10.1016/j.cell.2018.07.010
Goode, A., Gilbert, B., Harkes, J., Jukic, D., & Satyanarayanan, M. (2013). OpenSlide: A vendor-neutral software foundation for digital pathology. Journal of Pathology Informatics, 4(1), 27-27. doi:10.4103/2153-3539.119005
Heindl, A., Sestak, I., Naidoo, K., Cuzick, J., Dowsett, M., & Yuan, Y. (2018). Relevance of Spatial Heterogeneity of Immune Infiltration for Predicting Risk of Recurrence After Endocrine Therapy of ER+ Breast Cancer. JNCI: Journal of the National Cancer Institute, 110(2), 166-175. doi:10.1093/jnci/djx137
Hennig, C., Adams, N., & Hansen, G. (2009). A versatile platform for comprehensive chip-based explorative cytometry. Cytometry A, 75(4), 362-370. doi:10.1002/cyto.a.20668
Hijmans, R. J., Phillips, S., Leathwick, J., & Elith, J. (2017). dismo: Species Distribution Modeling. Retrieved from https://CRAN.R-project.org/package=dismo
Khan, A. M., Rajpoot, N., Treanor, D., & Magee, D. (2014). A Nonlinear Mapping Approach to Stain Normalization in Digital Histopathology Images Using Image-Specific Color Deconvolution. IEEE Transactions on Biomedical Engineering, 61(6), 1729-1738. doi:10.1109/TBME.2014.2303294
Kiemen, A., Braxton, A., Grahn, M., Han, K. S., Babu, J. M., Reichel, R., . . . Wirtz, D. (2020). In situ characterization of the 3D microanatomy of the pancreas and pancreatic cancer at single cell resolution: bioRxiv.
Klein, S., Staring, M., Murphy, K., Viergever, M. A., & Pluim, J. P. (2010). elastix: atoolbox for intensity-based medical image registration. IEEE Trans Med Imaging, 29(1), 196-205. doi:10.1109/TMI.2009.2035616
Kybic, J., & Borovec, J. (2014). Automatic Simultaneous Segmentation and fast Registration of histological images.
Kybic, J., Dolejši, M., & Borovec, J. (2015). Fast registration of segmented images by normal sampling.
Levy, J. J., Jackson, C. R., Haudenschild, C. C., Christensen, B. C., & Vaickus, L. J. (2020). PathFlow-MixMatch for Whole Slide Image Registration: An Investigation of a Segment-Based Scalable Image Registration Method. bioRxiv, 2020.2003.2022.002402. doi:10.1101/2020.03.22.002402
Lewis, S. M., Asselin-Labat, M. L., Nguyen, Q., Berthelet, J., Tan, X., Wimmer, V. C., . . Naik, S. H. (2021). Spatial omics and multiplexed imaging to explore cancer biology. Nat Methods, 18(9), 997-1012. doi:10.1038/s41592-021-01203-6
Li, C., Li, Z., Wang, Z., Xu, Y., Luo, M. R., Cui, G., . . . Pointer, M. (2017). Comprehensive color solutions: CAM16, CAT16, and CAM16-UCS. Color Research & Application, 42(6), 703-718. doi:https://doi.org/10.1002/col.22131
Li, L., Huang, W., Gu, I., & Tian, Q. (2003). Foreground object detection from videos containing complex background.
Linkert, M., Rueden, C. T., Allan, C., Burel, J. M., Moore, W., Patterson, A., . . . Swedlow, J. R. (2010). Metadata matters: access to image data in the real world. J Cell Biol, 189(5), 777-782. doi:10.1083/jcb.201004104
Lowekamp, B. C., Chen, D. T., Ibanez, L., & Blezek, D. (2013). The Design of SimpleITK. Front Neuroinform, 7, 45. doi:10.3389/fninf2013.00045
Maley, C. C., Koelble, K., Natrajan, R., Aktipis, A., & Yuan, Y. (2015). An ecological measure of immune-cancer colocalization as a prognostic factor for breast cancer. Breast Cancer Res, 17(1), 131. doi:10.1186/s13058-015-0638-4
Marstal, K., Berendsen, F., Staring, M., & Klein, S. (2016, 26 June-1 Jul. 2016). SimpleElastix: A User-Friendly, Multi-lingual Library for Medical Image Registration. Paper presented at the 2016 IEEE Conference on Computer Vision and Pattern Recognition Workshops (CVPRW).
Martinez, K., & Cupitt, J. (2005). VIPS—a highly tuned image processing software architecture. Paper presented at the IEEE International Conference on Image Processing (31/08/05). https://eprints.soton.ac.uk/262371/
Muhlich, J., Chen, Y.-A., Russell, D., & Sorger, P. K. (2021). Stitching and registering highly multiplexed whole slide images of tissues and tumors using ASHLAR software. bioRxiv, 2021.2004.2020.440625. doi:10.1101/2021.04.20.440625
Obando, D. F. G., Frafjord, A., Oynebraten, I., Corthay, A., Olivo-Marin, J., & Meas-Yedid, V. (2017, 18-21 Apr. 2017). Multi-staining registration of large histology images. Paper presented at the 2017 IEEE 14th International Symposium on Biomedical Imaging (ISBI 2017).
Paknezhad, M., Loh, S. Y. M., Choudhury, Y., Koh, V. K. C., Yong, T. T. K., Tan, H. S., . . . Lee, H. K. (2020). Regional registration of whole slide image stacks containing major histological artifacts. BMC Bioinformatics, 21(1), 558. doi:10.1186/s12859-020-03907-6
Popovic, G. C., Warton, D. I., Thomson, F. J., Hui, F. K. C., & Moles, A. T. (2019). Untangling direct species associations from indirect mediator species effects with graphical models. Methods in Ecology and Evolution, 10(9), 1571-1583. doi:10.1111/2041-210X.13247
R Core Team. (2019). R: A Language and Environment for Statistical Computing. Vienna, Austria: R Foundation for Statistical Computing. Retrieved from https://www.R-project.org/
Ripley, B. D. (1977). Modelling Spatial Patterns. Journal of the Royal Statistical Society. Series B (Methodological), 39(2), 172-212.
Ripley, B. D. (1981). Spatial Statistics. New York: John Wiley & Sons.
Shamonin, D. P., Bron, E. E., Lelieveldt, B. P., Smits, M., Klein, S., Staring, M., & Alzheimer's Disease Neuroimaging, I. (2013). Fast parallel image registration on CPU and GPU for diagnostic classification of Alzheimer's disease. Front Neuroinform, 7, 50. doi:10.3389/fninf2013.00050
Simonyan, K., Vedaldi, A., & Zisserman, A. (2014). Learning Local Feature Descriptors Using Convex Optimisation. IEEE Transactions on Pattern Analysis and Machine Intelligence, 36(8), 1573-1585. doi:10.1109/TPAMI.2014.2301163
Song, Y., Treanor, D., Bulpitt, A. J., & Magee, D. R. (2013). 3D reconstruction of multiple stained histology images. J Pathol Inform, 4(Suppl), S7. doi:10.4103/2153-3539.109864
Traag, V. A., Waltman, L., & van Eck, N. J. (2019). From Louvain to Leiden: guaranteeing well-connected communities. Sci Rep, 9(1), 5233. doi:10.1038/s41598-019-41695-z
Wang, C. W., Ka, S. M., & Chen, A. (2014). Robust image registration of biological microscopic images. Sci Rep, 4, 6050. doi:10.1038/srep06050
Weinzaepfel, P., Revaud, J., Harchaoui, Z., & Schmid, C. (2013, 1-8 Dec. 2013). DeepFlow: Large Displacement Optical Flow with Deep Matching. Paper presented at the 2013 IEEE International Conference on Computer Vision.

1. A computer-implemented method for slide image registration, the computer-implemented method comprising:
receiving a plurality of slide images;
detecting a plurality of features contained in the slide images;
comparing a plurality of pairs of the slide images, wherein the comparison uses the detected features;
creating a distance matrix that reflects a respective difference between each of the pairs of the slide images;
ordering, using the distance matrix, the slide images to create a slide image series;
determining a plurality of transformation matrices for registering the slide images, wherein a respective transformation matrix rigidly aligns a first slide image (Iᵢ) to a second slide image (Iᵢ₋₁), wherein i is the position of a slide image within the slide image series, and wherein the respective transformation matrix that rigidly aligns the first and second slide images is determined using a set of the detected features shared by neighboring slide images in the slide images series; and
rigidly aligning the slide images using the transformation matrices.

2. The computer-implemented method of claim 1, further comprising determining a plurality of non-rigid transformations for non-rigidly registering the rigidly aligned slide images, wherein a respective non-rigid transformation non-rigidly aligns a first rigidly aligned slide image (Jᵢ) to a second rigidly aligned slide image (Jᵢ₋₁), wherein i is the position of a rigidly aligned slide image within the slide image series.

3. The computer-implemented method of claim 2, further comprising non-rigidly aligning the rigidly aligned slide images using the non-rigid transformations.

4. The computer-implemented method of claim 1, further comprising identifying the set of the detected features shared by the neighboring slide images using a sliding window filter.

5. The computer-implemented method of claim 1, wherein the neighboring slide images comprises the first slide image and a third slide image (Iᵢ₊₁).

6. The computer-implemented method of claim 5, wherein the neighboring slide images further comprise the second and third slide images.

7. The computer-implemented method of claim 1, wherein comparing a plurality of pairs of the slide images comprises comparing each one of the slide images to each of the other slide images, wherein the distance matrix is created from the comparison.

8. The computer-implemented method of claim 1, wherein the step of ordering, using the distance matrix, the slide images to create the slide image series comprises sorting the distance matrix by performing hierarchical clustering.

9. The computer-implemented method of claim 8, wherein sorting the distance matrix by performing hierarchical clustering yields a dendrogram.

10. The computer-implemented method of claim 9, wherein the dendrogram comprises a plurality of leaves, each leaf corresponding to one of the slide images.

11. The computer-implemented method of claim 10, further comprising performing optimal leaf ordering on the dendrogram.

12. The computer-implemented method of claim 1, further comprising optimizing the alignment of one or more of the slide images in the slide image series.

13. The computer-implemented method of claim 1, further comprising pre-processing the slide images.

14. The computer-implemented method of claim 1, further comprising overlaying the aligned slide images for display on a graphical interface.

15. The computer-implemented method of claim 1, wherein the slide images are whole slide images or regions of interest (ROI), stained using immunohistochemistry (IHC) or immunofluorescence (IF), coming from serially sliced samples, or cyclically stained samples.

16. The computer-implemented method of claim 1, further comprising generating a non-rigid registration mask by combining tissue masks for each of the rigidly-aligned slide images, wherein the non-rigid registration mask includes only areas where the tissue masks for each of the rigidly-aligned slide images overlap or touch.

17. The computer-implemented method of claim 16, wherein the plurality of slide images is a first set of slide images, the computer-implemented method further comprising:
receiving a second set of slide images, wherein the second set of slide images has a higher resolution than the first set of slide images;
using the non-rigid registration mask to identify a portion of at least one of the second set of slide images that includes an area of tissue shown in the first set of slide images; and
repeating the computer-implemented method using the portion the at least one of the second set of slide images.

18. The computer-implemented method of claim 1, wherein the plurality of slide images is a first set of slide images, the computer-implemented method further comprising:
receiving a second set of slide images, wherein the second set of slide images has a higher resolution than the first set of slide images;
repeating the computer-implemented method using the second set of slide images;
determining a plurality of non-rigid transformations for non-rigidly registering the rigidly aligned second set of slide images, wherein a respective non-rigid transformation non-rigidly aligns a first rigidly aligned slide image (Jᵢ) to a second rigidly aligned slide image (Jᵢ₋₁), wherein i is the position of a rigidly aligned slide image within the slide image series.

19. The computer-implemented method of claim 18, wherein, prior to repeating the computer-implemented method using the second set of slide images, each of the second set of slide images is divided into a plurality of tiles, wherein each of the plurality of tiles are used to repeat the computer-implemented method.

20. A system comprising:
a processor; and
a memory operably coupled to the processor, the memory having computer-executable instructions stored thereon that, when executed by the processor, cause the processor to:
receive a plurality of slide images;
detect a plurality of features contained in the slide images;
compare a plurality of pairs of the slide images, wherein the comparison uses the detected features;
create a distance matrix that reflects a respective difference between each of the pairs of the slide images;
order, using the distance matrix, the slide images to create a slide image series;
determine a plurality of transformation matrices for registering the slide images, wherein a respective transformation matrix rigidly aligns a first slide image (Iᵢ) to a second slide image (Iᵢ₋₁), wherein i is the position of a slide image within the slide image series, and wherein the respective transformation matrix that rigidly aligns the first and second slide images is determined using a set of the detected features shared by neighboring slide images in the slide images series; and
rigidly align the slide images using the plurality of transformation matrices.

21. The system of claim 20, wherein the instructions further cause the processor to determine a plurality of non-rigid transformations for non-rigidly registering the rigidly aligned slide images, wherein a respective non-rigid transformation non-rigidly aligns a first rigidly aligned slide image (Jᵢ) to a second rigidly aligned slide image (Jᵢ₋₁), wherein i is the position of a rigidly aligned slide image within the slide image series.

22. The system of claim 21, wherein the instructions further cause the processor to non-rigidly align the rigidly aligned slide images using the non-rigid transformations.

23. The system of claim 20, wherein the instructions further cause the processor to identify the set of the detected features shared by the neighboring slide images using a sliding window filter.

24. The system of claim 20, wherein the slide images are whole slide images or regions of interest (ROI), stained using immunohistochemistry (IHC) or immunofluorescence (IF), coming from serially sliced samples, or cyclically stained samples.
